(19) United States
(12) Patent Application Publication
(10) Pub. No.: US 2003/0108189 A1
(43) Pub. Date: Jun. 12, 2003

(54) Method and device for identifying and notifying the recipient of a phone call using a distinct phone ring pattern assigned to that call recipient

(76) Inventor: Shimon Barzani, Haifa (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(21) Appl. No.: 10/012,382

(22) Filed: Dec. 12, 2001

(51) Int. Cl. H04M 1/00; H04M 3/00

(52) U.S. Cl. 379/373.02

(57) ABSTRACT

The invention is a method and device for identifying and notifying the recipient of a phone call, prior to the call being answered, using distinctive aural clues, such a unique phone ring pattern or melody, or distinctive lighting clues, pre-assigned to each phone call recipient and by which each recipient recognizes the call as being intended for them. The invention achieves call recipient identification by allowing the caller either to select the intended recipient from a list automatically announced when she calls by typing in a code associated with each recipient on the list or by directly typing in a pre-assigned code unique to the intended call recipient. The phone then rings in a distinctive manner, deploying a unique ring pattern or melody, or lights up in a distinctive manner, previously assigned and known to the call recipient, thus providing a clear clue as to the identity of the intended call recipient. The uniquely assigned phone ring pattern or lighting pattern is recognized by its owner (the call recipient), who then answers the phone in the certain knowledge that the phone call is directed to him or her. If the intended recipient is not present or does not answer the call, the invention provides for the possibility of a voice message to be left by the caller in that individual's voice mailbox. The intended recipients can then retrieve voice messages left for them at their own leisure and convenience, using their own private password to access their personal voice mailbox

### FIELD AND BACKGROUND OF THE INVENTION

1. Field of the Invention

The present invention relates to a system for enabling telephonic communication, and more specifically it concerns a method and apparatus for identifying and notifying the recipient of a phone call using a distinctive phone ring pattern or melody assigned specifically to the phone call recipient.

2. Description of the Related Art

It is known that many households, dormitories and offices having multiple users encounter the problem of phone calls that interrupt and distract the attention of all the users. Usually these phone calls are not answered directly by the intended call recipient. While methods exist to identify the caller or type of call and direct it to a relevant phone extension, there is no effective method to identify the recipient of the call before the call has been answered

This problem is even more acute in the case of a household or dormitory having a single phone device or line serving or shared by all the residents. In such cases, when a call is received, there is no effective indicator as to the call's intended recipient and this requires anyone at hand to answer the call, check with the caller as to the identity of the call recipient and then get the recipient to answer the call.

Obviously, this process of identifying the call recipient is time-consuming, inefficient and even annoying to all the parties involved (the caller, answerer and call recipient).

An extension of this is the inconvenience that callers often experience when trying to contact individuals, and are forced to leave messages with third parties, who, for various reasons, fail to give those messages to the person/s intended.

U.S. Pat. No. 5,828,742 describes a method for a telephone subscriber to distinguish between callers. The method is accomplished by storing a pass code for a subscriber's telephone within a memory of the telephone system. Callers who have been informed of the pass code and who call the subscriber's telephone and enter the pass code to receive special treatment. For example, upon the caller calling the subscriber's telephone, a normal ringing pattern is applied to the subscriber's telephone while a ring back signal is returned to the caller. Upon the caller entering the pass code, a special ringing pattern is applied to the subscriber's telephone. The special ringing pattern is different than the normal ringing pattern and thus indicates to a subscriber of the subscriber's telephone, even before the telephone is answered, that the caller is one of a select group of callers to whom the subscriber has shared the pass code. The '742 invention therefore enables different rings for identification of different callers. However the '742 invention provides a solution for identifying callers, provided to particular callers who are given particular codes. This is not useful for unexpected or uninformed callers, who have not been previously provided with such a code. Furthermore, this method does not provide a solution to multiple call receivers on a single line, as even for those callers who know and use the code, it cannot be determined by the callers whom they would like to speak to.

U.S. Pat. No. 5,333,190 describes a ring detection device adapted to be connected in a telephone line to a telephone or telephone device. The device includes circuitry for distinguishing between several differently encoded telephone ring signals and enabling and/or maintaining disablement of the telephone or telephone device to which it is connected, based upon such distinction. The device includes a switch for selecting which of the incoming telephone ring signals the telephone or telephone device to which is it connected is enabled. The '190 invention therefore enables users of a single telephone line system to select which telephone devices will respond to which incoming calls, such that call receivers can receive calls intended for them to particular telephones only. This is only useful, however, where different users of the line have separate telephone devices.

There is therefore a need for a method of enabling a caller to define a particular call recipient of a shared telephone device in a household/dormitory etc., such that the particular recipient is automatically identified when an incoming call is made, in order to avoid stopping the activities of non-relevant members each time the phone rings. Such a method should ideally provide effective means to identify the recipient of a phone call even before the call has been answered.

### SUMMARY OF THE INVENTION

According to the present invention there is provided a Directed Phone Call (DPC) device and accompanying method for identifying the recipient of a phone call on a shared telephone device. Such a device and method enable a caller to define and notify a particular call recipient, such that the call recipient may recognize that the call as being intended for them, prior to the call being answered. This is enabled using distinctive aural clues such a unique phone ring pattern or melody pre-assigned to each phone call recipient.

The present invention achieves call recipient identification by allowing the caller either to select the intended recipient from a list automatically announced when s/he calls by typing in a code (preferably a single-digit number) associated with each recipient on the list or by directly typing in a pre-assigned code unique to the intended call recipient.

The phone then rings in a distinctive manner, deploying a unique ring pattern or melody previously assigned and known to the call recipient, thus providing a clear aural clue as to the identity of the intended call recipient.

The uniquely assigned phone ring pattern or melody is recognized by the relevant call recipient, who then answers the phone with the knowledge that the phone call is directed to him/her. Other residents or users of the household or dormitory may disregard the received phone call, as they can be certain that this distinctive ring pattern or melody is not the one assigned to them, and they can therefore continue their business without answering the call.

If the intended recipient is not present or does not answer the call, the invention provides for the possibility of a voice message to be left by the caller in the designated recipient's private voice mailbox. The intended recipient can then retrieve voice messages left for them at their own leisure and convenience, using their own private password to access their personal voice mailbox.

According to the teachings of the present invention there is provided a programmable hardware module (microprocessor based) that is configured as either an internal part of a telephone unit or an external one connected to an existing unit that facilitates the single telephone line functioning like a multi-party telephone system. The module converts a user identifying code, inputted by the caller, to the desired recipient's personal ringing tone or melody.

According to the teachings of the present invention a method is also provided by which the module is able to connect with and use a voicemail system (prior art) in the event that the call is not answered.

Thus, the present invention is optimally suited to situations such as a household with teenagers, students living in the same dormitory room or floor or office workers sharing a single phone line or receiving calls from their personal clients. The present invention eliminates the need for everyone in this household or dormitory etc. to answer the phone, since a distinctive phone ring uniquely identifies each call-recipient. The invention also saves the time and attention of everyone, as each individual can quickly disregard a phone ring of an incoming call, once it is clear that it is not the unique ring pattern or melody assigned to that individual.

### BRIEF DESCRIPTION OF THE DRAWINGS

The invention is herein described, by way of example only, with reference to the accompanying drawings, wherein:

FIG. 1 is a functional block diagram illustrating the components according to the present invention.

FIG. 2 is a flow chart detailing a method for notifying the phone call recipient with a unique, pre-assigned ring pattern or melody.

FIG. 3 is a flow chart detailing a method for configuring the recipient ring pattern.

### DESCRIPTION OF THE PREFERRED EMBODIMENT

According to the present invention there is provided a system and method identifying the recipient of a phone call on a shared telephone device. Such a method enables a caller to define and notify a particular call recipient, such that the call recipient may recognize that the call as being intended for them, prior to the call being answered. This is enabled using a Directed Phone Call (DPC) device that provides for configuring, managing and announcing distinctive aural clues such as distinctive phone ring patterns or melodies pre-assigned to each phone call recipient.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The principles and operation of a system and a method according to the present invention may be better understood with reference to the drawings and the accompanying description, it being understood that these drawings are given for illustrative purposes only and are not meant to be limiting.

Referring now to the drawings,

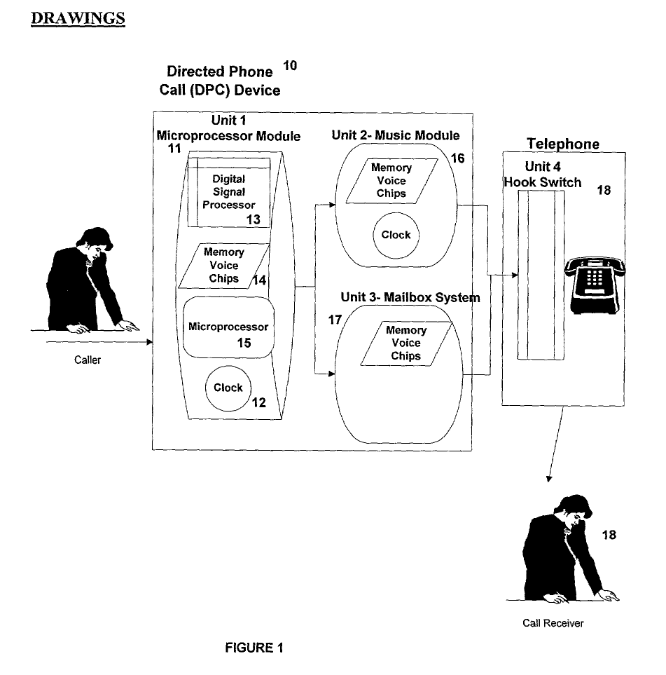

FIG. 1 illustrates the main components of the Directed Phone Call (DPC) Device 10, according to the present invention. As can be seen in the figure, the system components are as follows:

Unit no.1—A Microprocessor based Module (11)

i. Timer (clock) 12—for monitoring time periods between caller navigation decisions, and thereby activating a general ring if no code recipient was typed, as well as activating access to recipient voicemail boxes if calls are not answered.

ii. DSP (digital signal processor) 13—DSP is a special-purpose CPU used for digital signal processing. It provides ultra-fast instruction sequences, such as shift and add, and multiply and add, which are commonly used in math-intensive signal processing applications. The DSP of the present invention is used for converting the digit (recipient code that was typed) to a signal, thereby enabling the specific memory voice chip to play music.

iii. Memory voice chips 14, such as Programmable Read Only Memory (PROM) or the equivalent, for announcing interactive menus, such as the various recipients and their codes, various means to navigate the system, audio (musical) data and various other messages and announcements. This chip can be burned and re-burned for storing data, such as musical data.

iv. Microprocessor 15—for managing the configuration process and system maintenance, including storing system and user data.

Unit no. 2: Music Module (16)

i. memory voice chips, such as PROMs or the equivalent, for playing the melodies.

ii. Timer/clock—for stopping the ring after a period of time and directing the caller to the mailbox.

Unit no. 3 Mail Box (17)

i. memory voice chips, such as PROMs or the equivalent.

Unit no. 4—Hook Switch (18)

This unit is an existing component of a telephone system, which is either apart from the actual telephone device, or is combined with the telephone device. The Hook Switch enables stopping the melodies/ring when the call receiver picks up the phone, by closing the circuit, thereby enabling a telephonic conversation.

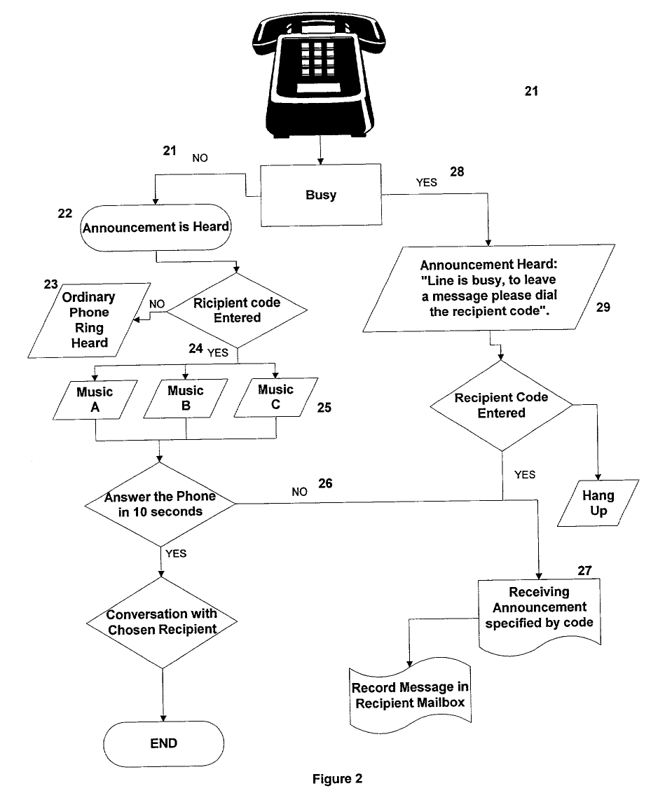

FIG. 2 is a flow chart detailing a method for notifying the phone call recipient with a unique, pre-assigned ring pattern or melody.

1) The call initiator picks up a phone and dials a phone number;

2) If the receiver line is available 21 to receive calls, the caller hears an announcement 22, such as: “You have reached phone no. ***. Please enter the recipient's code or “0” for anyone”.

3) If “0” is entered or no code is entered in 3-5 seconds—an ordinary phone ring will be heard 23. Where a code is entered 24 within the required time limit, the device of the present invention converts the phone ring to a specific ring 25 that belongs to the chosen call receiver.

4) If the receiver does not answer 26 the call for a defined period of time, the caller is transferred to the recipients mailbox where a receiving announcement 27 may be played, such as, “You have reached to mailbox of *** please record your message after the beep”.

5) The caller then records the voicemail message for the specific call receiver.

Similarly, in the case where the line is busy 28, the caller may be prompted with a message such as, “The phone line is busy. To leave a message, please type/dial a recipient code” 29. If the caller enters the code within a given time limit, the caller is transferred to the call receiver's mailbox, where he/she may be prompted to leave a message 27 for the specific (or general, in the case where “0” is entered . . . ) call receiver.

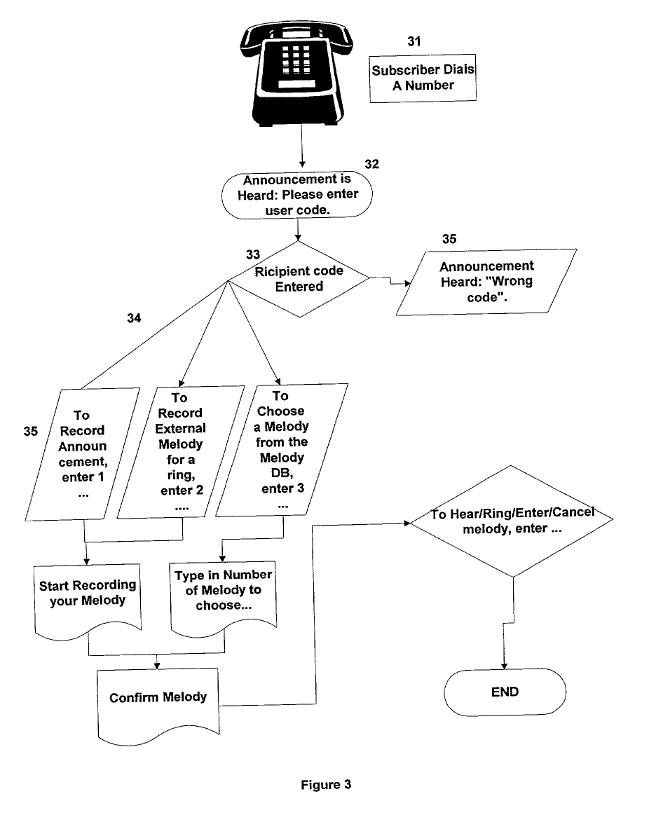

The Configuration of the DPC system can be executed as follows, as can be seen with reference to FIG. 3.

1. The user/subscriber (Call receiver) picks up his/her phone and dials a number 31 to access the system. This a general service number, such as the # symbol, which connects the user to the device's microprocessor for remote configuration. Configuration information, such as user and system data, is subsequently stored in the device microprocessor.

2. The user hears an announcement 32, such as, “Please enter your user code.”.

3. The user enters the code 33, and if a recognized code is entered 34, the user may hear a prompt 35 such as, “To record your announcement for voicemail, enter “1” to record . . . And # enter the recording”. Furthermore, the user may be prompted to record an external melody for his/her ring, or a pre-recorded melody from a data source of melodies for this purpose. For example, the user may be requested to, “enter “2” to hear samples of melodies. When you hear the sample you want to use, enter “#”.

4. The user may listen to the melody, confirm the melody, and end the configuration process, thereby entering or updating the user/subscriber ring configuration.

The method and device for identifying and then notifying the call recipient using aural clues includes the possibility of programming the system to assign a unique ring pattern to each user of the system and to assign the key or code associated with their names. Additionally the system allows for defining the opening message heard by incoming callers and for defining for each user a password used to access their voicemail.

The method of the present invention also allows the caller to activate the recipient-identifying unique ring pattern or melody by directly typing in a predefined code. This code is previously provided to any caller who wishes to directly request the recipient without listening to the system's opening message.

The present invention may be incorporated into a telecommunications system in the form of an external microprocessor-based module that is attached by a serial connection to a phone device, thus enabling the call recipient identification and notification functionality. Alternatively, the invention may be incorporated as an internal component of the phone system. The module is an internal operator that distinguishes between calls for the different parties that receive calls on that telephone line by requesting, via a recorded announcement, that the caller dial the intended recipient's code. With receipt of this code, the device identifies which ringing tone or melody to relay. The codes and their related melodies are prerecorded in the system.

Functionally, an incoming caller dials the desired telephone number, which is answered by the Microprocessor based module, and subsequently the caller is prompted for the desired recipient's ID/code. Following this that particular recipient's registered tone/melody will ring, telling the elected call recipient the call is for him/her. In the event that the call is unanswered, it will be diverted to a voicemail for that specific recipient where the caller can leave a message.

The present invention, furthermore, provides each user the option of changing the user's personal tone/melody, personalizing the user's voicemail message, and accessing that user's voicemail by using personal ID/code.

Moreover, the present invention provides a method by which the module is able to refer calls to a voicemail system (prior art) in the event that a call is not answered. If, for example, the call remains unanswered for 3-5 seconds, the module may trigger voicemail to answer the call. Each user has his/her own message-box, accessed by using individual user-codes.

In a further embodiment of the present invention, there is provided a means for enabling a recipient of a phone call on a shared telephone device to receive a personalized light signal, by which the recipient recognizes that the call is intended for him or herself only. Such an embodiment requires configuration by a subscriber, such that each subscriber of a shared phone line chooses a particular color light, or type of flashing, which subsequently flashes as configured when a call initiator makes a phone call to the particular subscriber. The integration of such a call lighting mechanism to a telephonic device would require a lighting unit on the telephone device, which would enable the flashing of various types of light flashes or colors. Such an integration would be obvious to one skilled in the art, based on the above described system and method.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A method for enabling a recipient of a phone call on a shared telephone device to receive a personalized phone ring pattern, by which the recipient recognizes that the call is intended for him or herself only, the method comprising the steps of:
a) intercepting a phone call to the call recipient, by a Directed Phone Call (DPC) device;
b) presenting said caller with a list of call receivers and means for accessing an intended recipient of said call;
c) selecting said intended recipient; and
d) executing a particular phone ring pattern, as pre-configured by said intended recipient of said call.

2. The method of claim 1, wherein during step (ii), said caller enters a pre-assigned code specific to said intended recipient in order to directly activate the recipient's pre-configured phone ring pattern.

3. The method of claim 1, further comprising:
(e) if said intended recipient does not answer said call, said call is directed to said intended recipient's personal voice mailbox.

4. The method of claim 3, wherein the recipient uses a pre-assigned code to access messages left in said personal voice mailbox.

5. The method of claim 1, wherein said DPC device enables each call receiver to determine phone ring patterns.

6. The method of claim 1, wherein said DPC device enables subscribers of said device to determine an opening message heard by callers upon activation of said DPC device.

7. The method of claim 3, wherein said DPC device enables each call receiver to determine an access code to access his/her voice mailbox.

8. A method for enabling a caller to identify a particular call receiver on a shared telephone device, such that a personalized phone ring pattern is used by which the particular recipient recognizes that the call is intended for him or herself only, the method comprising the steps of:
a) placing a phone call to a particular recipient's phone, by the caller;
b) intercepting said phone call before a Hook Switch of the call receiver's phone, by a DPC device;
c) presenting the caller with a list of users of said DPC device and an assigned code to be pressed to access the particular recipient of said call;
d) selecting the particular recipient's assigned code; and
e) executing a pre-configured phone ring pattern, chosen by the particular call recipient.

9. A system for enabling a phone call initiator to identify and notify a specific recipient of a phone call, prior to the call being answered, using a distinctive phone ring pattern or melody pre-assigned to the specific call recipient, by which each recipient of a shared phone device recognizes the call as being intended for them, the system comprising:
a) a Microprocessor-based module for processing data requests and storing system data;
b) a Music module for producing a plurality of distinctive phone ring patterns;

10. The system of claim 9, wherein said system further comprises:
(c) a voice mailbox system for enabling storing and retrieval of voicemail messages.

11. The system of claim 9, wherein said Microprocessor-based module further comprises:
a. a digital signal processor, for providing instruction sequences that enable said music module to play music;
b. at least one memory voice chip, for announcing system audio data; and
c. a microprocessor unit for managing system configuration and maintenance; and
d. a clock for monitoring time periods between caller navigation decisions.

12. The system of claim 9, wherein said DPC device is supplied as an external module to be attached to a regular phone, thus enabling call recipient identification and notification functionality.

13. The system of claim 9, wherein said Microprocessor-based module is incorporated as an internal component of a phone set, thus enabling call recipient identification and notification functionality.

14. A method for enabling a subscriber to configure a personalized phone ring pattern when receiving phone calls intended for the particular subscriber, the method comprising:
i. dialing a configuration number to connect to a Directed Phone Call (DPC) device, by the subscriber;
ii. entering a subscriber code, in order to access said DPC device;
iii. entering a preferred phone ring pattern, by the subscriber;
iv. confirming said phone ring pattern; and
v. configuring said phone ring pattern into said DPC device.

15. The method of claim 14, wherein said entering a preferred phone ring pattern further comprises the steps selected from the group consisting of recording a voicemail announcement message, recording an external ring pattern and choosing a pre-recorded ring pattern from a ring pattern database.

16. A system for enabling a call initiator to identify and notify a specific recipient of a phone call, prior to the call being answered, using a distinctive call lighting mechanism pre-assigned to the specific call recipient, by which each recipient of a shared phone device recognizes the call as being intended for them, the system comprising:
a) a Directed Phone Call device for processing requests and storing data; and
b) a call lighting mechanism for produce various lighting signals.
